(19) United States
(12) Patent Application Publication
(10) Pub. No.: US 2011/0317008 A1
(43) Pub. Date: Dec. 29, 2011

(54) AIRPORT/AIRCRAFT SECURITY

(75) Inventor: Jonathan Sam, Haverhill, MA (US)

(73) Assignee: ANALOGIC CORPORATION, Peabody, MA (US)

(21) Appl. No.: 12/825,444

(22) Filed: Jun. 29, 2010

(51) Int. Cl. H04N 7/18

(52) U.S. Cl. 348/143; 348/E07.085

(57) ABSTRACT

A information processor combines an image of one or more predetermined materials of interest from an image from a full body scan of a subject with video of the subject and generates data including both the image of the one or more materials of interest and the video of the subject. A method includes obtaining a sub-portion of an image that includes a predetermined material of interest. The image is generated via a full body scan of a subject during airport screening utilizing non-ionizing radiation. The method further includes obtaining video of the subject captured while the subject is at the airport. The method further includes combining the sub-portion of the image and the video to generate video or an image of the subject clothed with the sub-portion of the image superimposed over the clothing.

### TECHNICAL FIELD

The following generally relates to airport/aircraft security and is described with particular application to screening a passenger, utilizing augmented reality, prior to the passenger boarding an aircraft; however, the following also applies to other applications, including non-airport and/or aircraft related applications and other airport and/or aircraft related applications.

### BACKGROUND

Every day, large volumes of people travel by way of aircraft, making the airlines (the airport and/or aircrafts) attractive targets for terrorism, including hijacking aircraft and using hijacked aircraft as lethal weapons. Airport security provides a defense against terrorism by attempting to stop would-be attackers from bringing weapons, explosive materials, and/or other potentially lethal contraband into the airport.

An early line of defense was the Sky Marshal, which is an undercover law enforcement or counter terrorist agent on board a commercial aircraft. However, there were insufficient numbers of Sky Marshals to protect every flight. Consequently, all airlines begin screening passengers and their carry-on baggage. Other lines of defense include metal detectors, baggage x-ray machines, puffer machines (which can detect extremely small traces of compounds of interest), and explosive detection machines (which detect volatile compounds given off from explosives using gas chromatography), and backscatter x-ray scanners that detect hidden weapons and explosives on passengers. In the United States, the terrorist attack on Sep. 11, 2001 prompted even tougher regulations, such as limiting the number of and types of items passengers could carry on board aircraft, requiring increased screening for passengers who fail to present a government issued photo ID, and limiting the ability of non-passengers to meet arriving friends or relatives at their gates.

A more recent trend is to use a full body scanner on airline passengers, such as a scanner that emit non-ionizing electromagnetic radiation in the extremely high frequency (e.g., millimeter wave) radio frequency band. Generally, clothing is translucent to electromagnetic radiation in this band whereas the body and/or objects on the body such as contraband are not, and the wave energy reflected back from the body and/or the other objects on the body is used to construct an image. Unfortunately, the images provide a virtual strip-search of a passenger by making clothing transparent and showing the passenger virtually naked or showing other personally sensitive items unrelated to security threats. As a consequence, use of these scanners has generated concerns over privacy related to the revealing nature of the images.

Some approaches have been employed to minimize or eliminate privacy concerns. Examples of this include blurring the passenger's face, looking at the image in a separate room, and blurring the genitalia in the image. Unfortunately, these and other approaches have had limited success and have not both eliminated the privacy issue and retained the full utility of the scanning technique.

### SUMMARY

Aspects of the application address the above matters, and others.

In one aspect, an information processor combines an image of one or more predetermined materials of interest from an image from a full body scan of a subject with video of the subject and generates data including both the image of the one or more materials of interest and the video of the subject.

In another aspect, a method includes obtaining a sub-portion of an image that includes a predetermined material of interest. The image is generated via a full body scan of a subject during airport screening utilizing non-ionizing radiation. The method further includes obtaining video of the subject captured while the subject is at the airport. The method further includes combining the sub-portion of the image and the video to generate video or an image of the subject clothed with the sub-portion of the image superimposed over the clothing.

In another aspect, a computer readable storage medium encoded with instructions which, when executed by a processor of a computer, cause the processor to: employ augmented reality to combine a sub-portion of an image that includes a predetermined material of interest and video of the subject captured while the subject is at the airport, wherein the image is generated via a full body scan of a subject during airport screening utilizing non-ionizing radiation.

Those skilled in the art will recognize still other aspects of the present application upon reading and understanding the attached description.

### BRIEF DESCRIPTION OF THE DRAWINGS

The application is illustrated by way of example and not limitation in the figures of the accompanying drawings, in which like references indicate similar elements and in which:

FIG. 1 illustrates a system that facilitates aircraft and/or airport security based on full body scan data and video of a subject;

FIG. 2 illustrates non-limiting examples an information processor of the system of FIG. 1; and

FIG. 3 illustrates non-limiting method for facilitating aircraft and/or airport security via augmented reality.

### DETAILED DESCRIPTION

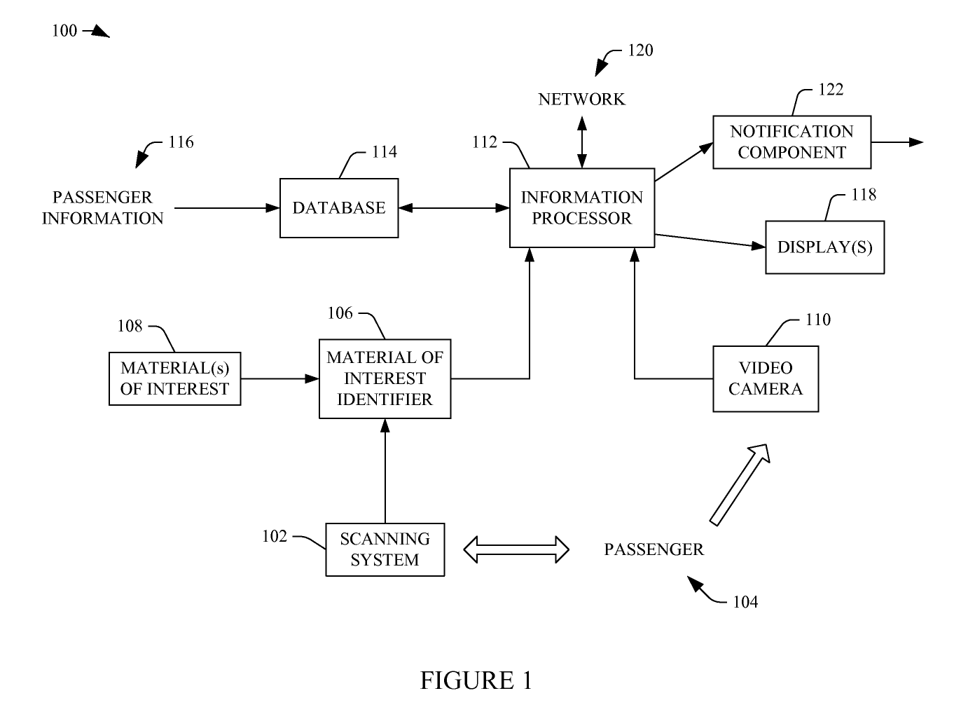

FIG. 1 illustrates a system 100 that facilitates airport/craft security at an airport. The system 100 includes a scanning system 102 for scanning a passenger 104. In the illustrated embodiment, the scanning system 102 includes a full body scanner. An example of a suitable full body scanner includes, but is not limited to, an extremely high frequency (e.g., millimeter wave) full body scanner.

Such a scanner transmits non-ionizing electromagnetic radiation that generally traverses clothing and the like but not the human body or objects thereon such that the radiation incident on the body and/or the objects is reflected back. The electromagnetic radiation can be transmitted from multiple antennas (as the antennas rotate around the body) or the like. The wave energy reflected back from the body and/or other objects on the body is detected and can be used to construct an image of the body and the contraband.

A material of interest (MOI) identifier 106 identifies one or more predetermined materials of interest 108 in the image generated by the scanning system 102. Examples of materials of interest include contraband such as weapons, non-weapon items that can be employed as weapons, explosives, and/or other materials of interest.

The MOI identifier 106 may be configured to automatically distinguish image pixels representing the human body and image pixels representing a material of interest, identify one or more materials of interest based at least thereon, and generate a sub-image that includes substantially only the portion of the image corresponding to the identified material(s) of interest. In another embodiment, the identification of a material of interest may be achieved either manually by an operator or semi-automatically in connection with input by the operator.

A video camera 110 acquires motion (and/or still picture) of one or more subjects (e.g., a passenger) at the airport. The illustrated video camera 110 can be an analog or a digital camera, and may include local storage for storing acquired data. One or more of the video cameras 110 can be selectively installed throughout and/or outside of an airport for continuous or periodic acquisition of the one or more subjects. This may include placing one or more video cameras 110 at particular locations such as at a security screening checkpoint, at a gate, and/or elsewhere.

An information processor 112 processes the sub-image generated by the MOI identifier 106 (which, as stated above, generally includes substantially only the portion of the image corresponding to any identified material of interest (in contrast to the portion of the image corresponding to human body)) and data from the video camera 110, including the captured data corresponding to the one or more persons at the airport.

As described in greater detail below, in one embodiment, the information processor 112 employs an augmented reality approach and superimposes, merges, or otherwise combines the sub-image with the video (live and/or delayed) of the corresponding subject. The resulting data allows for revealing the identified material(s) of interest, which would otherwise be hidden (e.g., by clothes) or otherwise obscured from sight, without virtually removing the clothes from and exposing other areas of the human body. The foregoing may alleviate privacy concerns associated with an embodiment in which areas of the body other than just the material(s) of interest are also revealed.

Other information, for example, information from a database 114, may be included or provided in connection with the processed data. This information may include passenger information 116 such as the information provided by the passenger when purchasing tickets like, name, age, destination, length of days between round trips, whether the trip is one way or a round trip, the number of passengers flying together, method of payment, passport number, driver's license number, etc.

One or more displays 118 are used to present or display the processed data from the information processor 112. It is to be appreciated that one or more of the displays 118 may be local to the airport, for example, in a security guard room accessed by authorized personnel, and/or remote from the airport, for example, in a police station, a private security company, and the like. Furthermore, the displays 118 may include wall mount displays, table top displays, hand held displays, and/or other displays. Hand held displays may include dedicated dumb displays and/or be part of a portable hand held device such as a cell phone, a personal data assistant (PDA), a hand held computer, or the like.

The processed data can be provided over a network 120 to other airports, the Office of Homeland Security, law enforcement agencies, the federal bureau of investigation (FBI), the central intelligence agency (CIA), and the like. Information from the above and/or other sources may also be provided via the network 120 to the information processor 112.

The information processor 112 employs a notification component 122 to notify one or more authorized personnel regarding identification of one or more materials of interest in the image data from the scan. The notification component 122 can utilized various communication channels such as cell phone, telephone, pager, email, text message, instant message, visual indicator, audio indicator, and/or other communication channel.

It is to be appreciated that the information processor 112 may part of one or more computing systems, in which one or more processors thereof executes one or more computer readable instructions stored or encoded in one or more computer readable storage mediums (e.g., physical memory or the like) to implement the information processor 112.

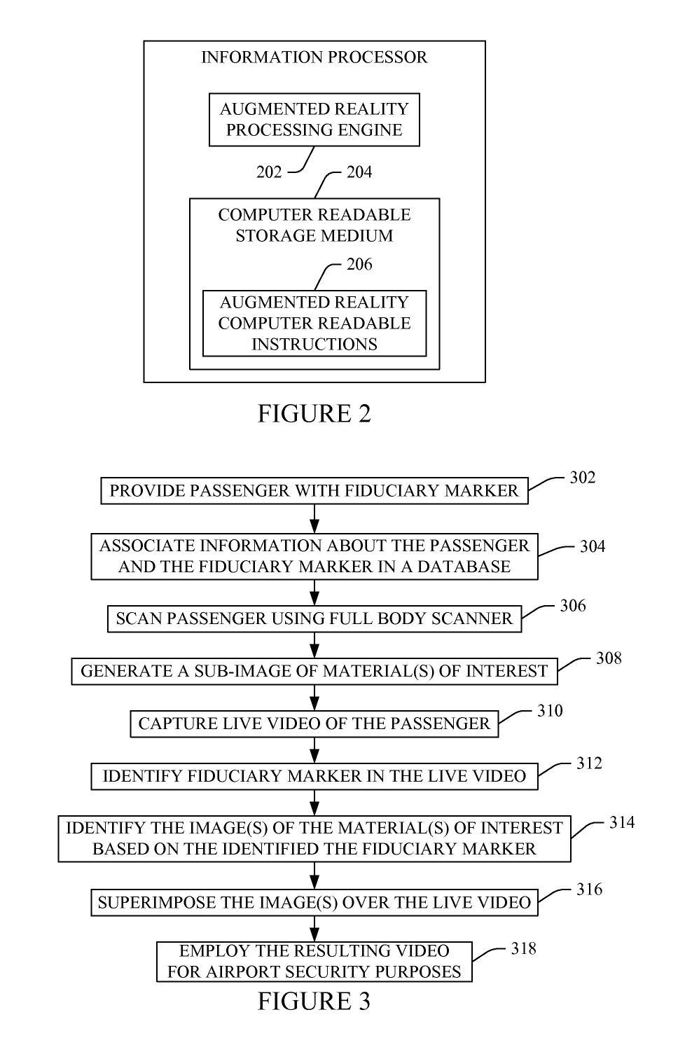

FIG. 2 illustrates an example information processor 112. In this embodiment, the information processor 112 employs augmented reality (combining the live physical real-world and computer-generated imagery). In other embodiments, other approaches are employed.

The illustrated information processor 112 includes an augmented reality processing engine 202 (with one or more processors) and computer readable storage medium 204 that includes one or more augmented reality computer readable instructions 206 that when executed by the one or more processors combine the information from the MOI identifier 106 and the video camera 110 based on augmented reality approaches to generate live video (and/or one or more still images) showing the video (and/or still image(s)) with the sub-image from the MOI identifier 106 superimposed thereon.

With this embodiment, a passenger is given a unique fiduciary marker (e.g., in a necklace, a badge, etc.) that would act as a datum point and/or electronic identifier for the passenger. The unique fiduciary marker is associated with the passenger information in the database 114, and the sub-image of the material of interest from the MOI identifier 106 is also associated with the passenger information in the database 114. This can be achieved through a look up table, linked databases using keys, and/or otherwise.

Passengers would carry or wear the marker until the security screening process is complete. For screening, the information processor 112 identifies and recognizes the fiduciary marker in the video. By way of non-limiting example, the fiduciary marker may be a light-emitting diode (LED) that emits lights having a wavelength within a predetermined wavelength range and which can be identified in the live video and/or image(s). The information processor 112 can use the fiduciary marker to identify the passenger and retrieve passenger information for the correct passenger and the image of the material of interest for the passenger from the database 114.

The information processor 112 then registers and superimposes the image of the identified material of interest over the live video (or still image) of the subject. In one embodiment, the information processor 112 places the image over the region of the subject corresponding to where the material of interest is located on the subject. In another embodiment, the image is placed elsewhere, such as in a region on or off the subject and dedicated for the image and/or elsewhere.

The resulting video (and/or image) includes a fully clothed passenger overlaid with the image of the identified material of interest. The foregoing may mitigate privacy concerns related to full body scans while retaining the usefulness of the information provided by the images and, thus, allows for full use of the full body scanning technology while maintaining a subject's privacy.

FIG. 3 illustrates a method for facilitating aircraft and/or airport security.

At 302, a passenger is provided with a fiduciary marker to carry and/or wear.

At 304, information about the passenger is associated with information about the fiduciary marker in a database.

At 306, the passenger is scanned via a full body scanning system via non-ionizing radiation, producing one or more images of the body of the passenger and one or more materials of interest (e.g., explosive materials, weapons, and the like) thereon.

At 308, a sub-image of the full body scan substantially only showing materials of interest is generated.

At 310, live video of the passenger is captured.

At 312, the fiduciary marker is identified in the live video.

At 314, the sub-image of the more material of interest for the passenger is identified based on the identified fiduciary marker.

At 316, video and/or a still mage(s) is generated for the passenger by superimposing the sub-image of the one or more material of interest over the subject in the live video and/or still image(s). As described herein, augmented reality can be employed where the generated video and/or still image(s) shows the passenger fully clothed with the identified material of interest merged with the video and/or still image(s).

As discussed herein, other information about the subject, such as information from the database 114 can also be merged with the video and/or still image(s), and the resulting the video and/or still image(s) can be provided to various authorized personnel to facilitate airport and/or aircraft security.

At 320, the generated video is employed for security purposes at an airport.

The application has been described with reference to various embodiments. Modifications and alterations will occur to others upon reading the application. It is intended that the invention be construed as including all such modifications and alterations, including insofar as they come within the scope of the appended claims and the equivalents thereof.

What is claimed is:

1. A system, comprising:
an information processor that combines an image of one or more predetermined materials of interest obtained from an image of a full body scan of a subject with video of the subject and generates data including both the image of the one or more materials of interest and the video of the subject.

2. The system of claim 1, wherein the generated data includes at least one of video or an image of the subject clothed with the image of the one or more materials of interest superimposed over the clothing.

3. The system of claim 2, wherein the full body scan is performed with non-ionizing electromagnetic radiation that traverses clothing and reflects off the body of the subject and materials of interest.

4. The system of claim 3, wherein the non-ionizing electromagnetic radiation has a wavelength in the millimeter band of the electromagnetic spectrum.

5. The system of claim 1, wherein the information processor identifies a fiduciary marker in the video of the subject and identifies the subject based on the identified fiduciary marker.

6. The system of claim 5, wherein the information processor obtains the image of one or more materials of interest based on the identified fiduciary marker.

7. The system of claim 6 wherein the information processor obtains information about the subject based on the identified fiduciary marker and includes the information with the generated data.

8. The system of claim 1, wherein the generated data includes substantially only a portion of the image from the full body scan corresponding to the one or more materials of interest.

9. The system of claim 1, wherein the generated data substantially does not include a portion of the image from the full body scan corresponding to the body of the subject.

10. The system of claim 1, wherein the one or more materials of interest includes at least one of a weapon or an explosive material.

11. The system of claim 1, wherein the generated data is utilized to facilitate at least one of airport or aircraft security.

12. The system of claim 1, wherein the information processor employs augmented reality to combine the image of the one or more materials of interest and the video of the subject.

13. The system of claim 1, wherein the information processor conveys the generated data to a law enforcement agency.

14. The system of claim 1, wherein the information processor conveys a message indicating that a material of interest has been identified in the image from the scan.

15. The system of claim 1, wherein the video of the subject is obtained during airport screening of subjects.

16. A method, comprising:
obtaining a sub-portion of an image that includes a predetermined material of interest, wherein the image is generated via a full body scan of a subject during airport screening utilizing non-ionizing radiation;
obtaining video of the subject captured while the subject is at the airport; and
combining the sub-portion of the image and the video to generate video or an image of the subject clothed with the sub-portion of the image superimposed over the clothing.

17. The method of claim 16, further comprising:
identifying a fiduciary marker in the video;
identifying the subject based on the fiduciary marker; and
obtaining the sub-portion of the image based on the identified identity of the subject.

18. The method of claim 16, wherein the generated data includes substantially only a portion of the image from the scan corresponding to the one or more materials of interest.

19. The method of claim 16, wherein the one or more materials of interest includes contraband of interest.

20. The method of claim 16, wherein the generated data is utilized to facilitate airport/aircraft security.

21. The method of claim 16, further comprising:
employing augmented reality to generate the video or the image.

22. A computer readable storage medium encoded with computer executable instructions, which, when executed by a processor of a computer, cause the processor to:
employ augmented reality to combine a sub-portion of an image that includes a predetermined material of interest and video of the subject captured while the subject is at the airport, wherein the image is generated via a full body scan of a subject during airport screening utilizing non-ionizing radiation.
